(19) United States
(12) Patent Application Publication
(10) Pub. No.: US 2022/0043786 A1
(43) Pub. Date: Feb. 10, 2022

(54) System and Method for Achieving Increased Accuracy of Extrapolated Vehicle Data

(71) Applicant: Arrivalist Co., New York, NY (US)

(72) Inventor: Cree Lawson, New York, NY (US)

(21) Appl. No.: 16/984,839

(22) Filed: Aug. 4, 2020

(51) Int. Cl. G06F 16/215; G07C 5/00; G06F 16/2458; G07C 5/08

(52) U.S. Cl. CPC G06F 16/215; G07C 5/0841; G06F 16/2462; G07C 5/008

(57) ABSTRACT

The present invention is a system and method for increasing the accuracy of insights derived from vehicle location data to the broader population using motor vehicle registration data. The process aligns at least two different data sets and normalizes the information by removing the bias from over-indexation within the data sets. In a particular implementation motor vehicle registration data is collected and the number of vehicles from a particular manufacturer is indexed against ZIP™ Code and third party data for each vehicle. The registration data is then increased or discounted to remove biases against greater numbers of vehicles from a single manufacturer over the average number registered in a ZIP™ Code, against commercial vehicles, and against newer vehicles over older vehicles.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

Motor vehicle location data insights can be collected by analyzing location data transmitted from a vehicle's built-in Global Positioning System (GPS) units or transmitted as GPS signals by smart devices located inside the vehicle.

If derived from devices sourced from one particular vehicle manufacturer or even from several vehicle manufacturers not representative of the traveling populace as a whole, these data are inherently biased toward the behaviors of people who purchase vehicles from those particular manufacturers. As long as the demographic information of only some road-borne vehicles is being actively collected, vehicle location data will not be representative of the movements of all vehicles. Additional data biases exist in the way private passenger vehicle data may be skewed by inadvertent collection of commercial vehicle data. No single section or segment of the motor vehicle market is representative of the whole.

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1 is a view of a sub-process for determining data biases consistent with certain embodiments of the present invention.

FIG. 2 is a view of a sub-process for removing data biases and processing a resulting data set consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language).

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

Reference throughout this document to “device” refers to any electronic communication device with network access such as, but not limited to, a cell phone, smart phone, tablet, iPad, networked computer, internet computer, laptop, watch or any other device, including Internet of Things devices, a user may use to interact with one or more networks.

However, unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device (such as a specific computing machine), that manipulates and transforms data represented as physical (electronic) quantities within the computer system memories or registers or other such information storage, transmission or display devices.

Certain aspects of the embodiments include process steps and instructions described herein. It should be noted that the process steps and instructions of the embodiments can be embodied in software, firmware or hardware, and when embodied in software, could be downloaded to reside on and be operated from different platforms used by a variety of operating systems. The embodiments can also be in a computer program product which can be executed on a computing system.

The embodiments also relate to an apparatus for performing the operations herein. This apparatus may be specially constructed for the purposes, e.g., a specific computer, or it may comprise a computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs and can be transient or non-transient medium, where a non-transient or non-transitory medium can include memory/storage that stores information for more than a minimal duration. Furthermore, the computers referred to in the specification may include a single processor or may be architectures employing multiple processor designs for increased computing capability.

The processes and displays presented herein are not inherently related to any particular computer or other apparatus. Various systems may also be used with programs in accordance with the teachings herein, or it may prove convenient to construct more specialized apparatus to perform the method steps. The structure for a variety of these systems will appear from the description herein. In addition, the embodiments are not described with reference to any particular programming language. It will be appreciated that a variety of programming languages may be used to implement the teachings of the embodiments as described herein, and any references herein to specific languages are provided for disclosure of enablement and best mode.

Collected vehicle location data is analyzed to provide insights in categories such as Origin Markets for a Particular Destination; Arrival Areas from a Particular Origin to Multiple Destinations; Trip Duration; Travel Patterns; How an origin point or destination point indexes vs. other origins and destinations within an area; Visits to Points of Interest Along a Trip; Commuting Patterns; Repeat Visits from a Particular Place or to a Particular Place; Most-Efficient Routing; Speed of Travel, and myriad others. Because not every passenger vehicle's location data is available for collection and analysis, there is a need for a system and method for correcting certain biases inherent in data that can be collected. Such biases manifest themselves when the source of location data is mainly from certain vehicles preferred by or largely driven by a non-representative subset of the travelling public at large. Other biases are extant by virtue of improper mixing of commercial vehicle location data with private passenger vehicle location data.

In an embodiment, the present innovation is an analytic software process for increasing the accuracy with which insights derived from vehicle location data are capable of extrapolation to the broader travelling population. The present innovation uses motor vehicle registration data, aligns at least two different data sets, and normalizes the information contained in the data sets by removing bias from over-indexation within the data sets. In a principal embodiment, motor vehicle registration data is collected and the number of vehicles manufactured by a particular manufacturer is indexed against postal code (hereinafter, ZIP™ Code) and population statistical data including city, state ZIP+4, counties, DMAs, MSAs, Regions, census tracks, census block data for each vehicle. Vehicle registration data is then increased or discounted to remove biases due to greater numbers of vehicles from a single manufacturer, registered within a particular geographical area represented by a ZIP™ Code, being overrepresented. The instant innovation also removes biases due to the presence of commercial vehicle data. The instant innovation can also parse data to differentiate data contributions made by newer vehicles versus data contributions made by older vehicles. In an embodiment, the foregoing process is conducted in real-time, with data analysis being completed virtually simultaneously with data collection. In so doing, the instant innovation improves the accuracy with which analysts may draw conclusions about the way people and motor vehicles are travelling.

In an embodiment, the instant innovation uses a digital device application to collect smart data about vehicles that pass physical checkpoints that are placed on or near roadways. This smart data is combined with location data from GPS sources within the vehicle (including from sources that are part of the vehicle itself). The instant innovation collects auto data plus registration data on a per ZIP™ Code basis in which motor vehicles manufactured by one or more particular manufacturer are registered. This collected data shows representation of movement all across the United States after the data is smoothed and biases are removed to normalize the data. Data Smoothing, Bias Removal, and Normalization allow analysts to understand the behavior of a human population over time as evidenced by movement of motor vehicles throughout the country.

In an embodiment, the sample of the population permits analysis of where and how people move within a particular state, and allows comparison and contrast to the movement of people within the country as a whole. Because the natural distribution of vehicles by state does not reflect movement of the population as a whole, the sample must be weight-adjusted for each user in the population.

In an embodiment, data collected includes raw latitude and longitude GPS information from a smart phone or other device contained within each vehicle or car, from which the location of the vehicle can be inferred. The data is updated dynamically and the instant innovation generates a prospective update of vehicle presence in the entire population based upon the sample produced as a forecast. The instant innovation utilizes Census Data along with vehicle registration data and correlates data to the ZIP™ Code each data set represents. The sample of data must be adjusted for the weight of the vehicles in the sample as a snapshot in time. This data is adjusted monthly over time.

In an embodiment, the data is adjusted for bias resulting from the presence of commercial vehicles in a data set. In so doing the instant innovation may be used to report data analysis of non-commercial vehicles only. Limiting data input can aid the system's determination of human behavior patterns that place vehicles in particular geographical spots or within certain discrete buckets of activity. Motor vehicle registration data is used as a source of truth regarding the demographic information of vehicle owners and registrants.

In an embodiment, the input data may also be adjusted to dynamically remove data resulting from operation of rental cars and other types of vehicles.

In an embodiment, the instant innovation collects motor vehicle registration data both from public sources and from data files transferred directly from one or more vehicle manufacturers. The innovation may then determine the number of first registered vehicles, manufactured by one or more particular manufacturers, that are linked to a particular ZIP™ Code. The instant innovation then determines the percentage of first registrations compared to the total vehicle registrations for that ZIP™ Code. The system determines whether that particular manufacturer (or subset of multiple manufacturers) over-indexes compared to the population as a whole. By way of non-limiting example, the system may have received as input vehicle location data from vehicles produced by Manufacturer A. If motor vehicle registration data shows that there are 50% more vehicle registrations of Manufacturer A vehicles in ZIP™ Code 34119 than in all other ZIP™ Codes, when creating insights regarding behavior within ZIP™ Code 34119 the system would discount the value of those vehicles by 33%. Such a discount prevents one ZIP™ Code's representation of Manufacturer A vehicles from being over represented in aggregated insights. Similarly, if the same manufacturer had 50% fewer vehicle registrations in ZIP™ Code 34120, then the system would double the weighting for vehicle location data that includes vehicles with the origin market of ZIP™ Code 34120.

Additionally, vehicle information may be received from source of truth comes from a 3rd party (like Polk Automotive) who get the owner demographic data from repair shops, oil change places, tire shops, etc

In an embodiment, the instant innovation uses similar practices in order to remove biases created by the presence of data originating from commercial vehicles being present in the data set. If commercial vehicles represent 50% more motor vehicle registrations in ZIP™ Code 34119 then they represent in all ZIP™ Codes combined then the system discounts results from this ZIP™ Code by 33.3% when including this ZIP™ Code in its calculations. Similarly, the instant innovation can compare the year and month of manufacture of all vehicles registered in a particular ZIP™ code to the year and month of manufacturer of the vehicles in the collected data set. The system may then apply a discount or a multiplier in order to remove bias toward vehicles based upon the age of the vehicles.

By removing unwanted demographic biases, the present innovation can aid in determining which vehicles are used for discretionary purposes—like going to the store to buy groceries or going on a road trip-versus which vehicles are used for commercial applications like delivering newspapers on a paper route. In an embodiment, the instant innovation uses the type of motor vehicle registration to remove the movement of commercial vehicles from its analysis. The innovation then balances the conclusions reached after data analysis by weighting its reports to correct for biases in an input data subset that do not apply to the broader vehicle-borne population. By balancing the degree to which a given subset is or is not reflective of the broader population the instant innovation can improve the accuracy of the insights produced through data extrapolation.

In an embodiment, the instant innovation can provide balanced insights based on vehicle location data which can then be used by and within certain digital applications. By way of non-limiting example, a digital application may calculate travel time within a certain region on a day-by-day and/or state-by-state basis. By balancing biases, the instant innovation makes less likely reports' being skewed in places where one manufacturer has a greater or lesser share of all motor vehicles in use.

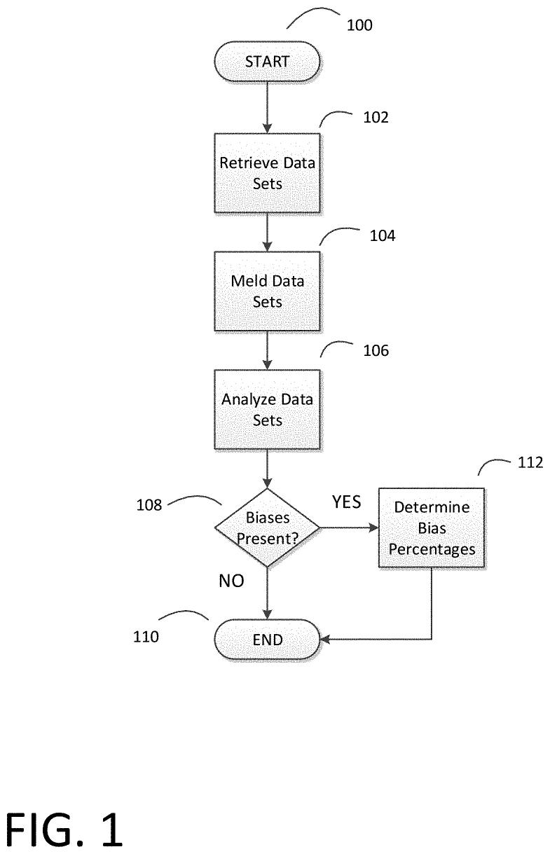

Turning now to FIG. 1, a view of a sub-process for determining data biases consistent with certain embodiments of the present invention is shown. At 100 the sub-process starts. At 102 the system retrieves two or more data sets. In an embodiment, one of the retrieved data sets is composed of motor vehicle registration data. At 104 the system melds the one or more data sets by indexing the data to the postal codes of the registered vehicle owners' addresses and aligning the fields of the one or more data sets. At 106 the system analyzes the Data Sets for the presence of Biases such as, by way of non-limiting example, those that reflect an over-representation within a postal code of vehicles manufactured by a particular manufacturer, or under-representation of vehicles of a certain age. This analysis results in Analyzed Data Sets. If at 108 no biases are present, then the sub-process ends at 110. If at 108 the system determines the presence of biases, then at 112 the system determines bias percentage. At 110 the sub-process ends.

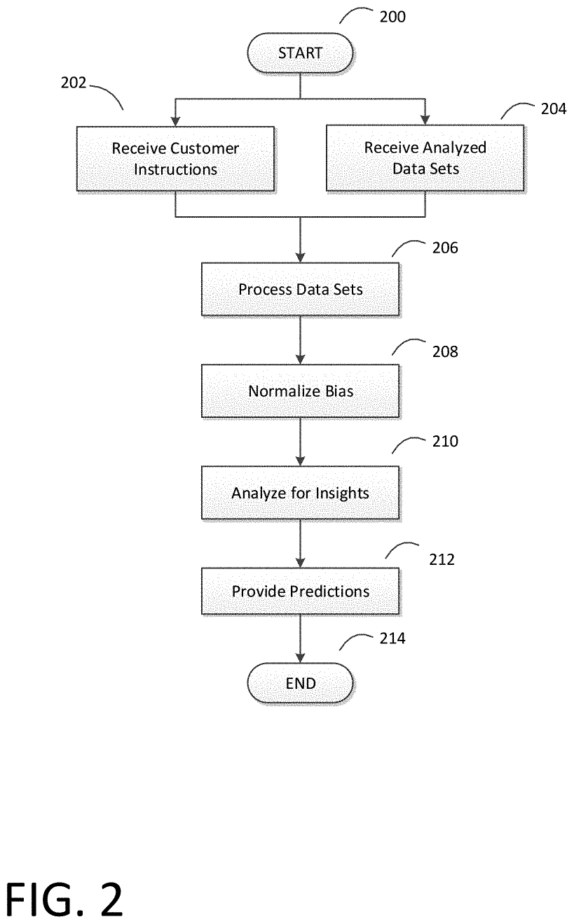

Turning now to FIG. 2, a view of a sub-process for removing data biases and processing a resulting data set consistent with certain embodiments of the present invention is shown. At 200 the sub-process starts. The system receives Customer Instructions at 202 and at 204 the system receives the Analyzed Data Sets described in FIG. 1. At 206 the system processes the Analyzed Data Sets in light of the Customer Instructions. By way of non-limiting example, Customer Instruction may direct analysis of traveler behavior upon a specific highway during a specific time of the day. At 208 the system normalizes for the percentage bias determined as described in FIG. 1. Such normalization may also be accompanied by Data Smoothing. At 210 the system analyzes the normalized output for forward-looking insights into human behavior. At 112 the system provides predictions regarding future human behavior in the form of a report. At 114 the sub-process ends.

While certain illustrative embodiments have been described, it is evident that many alternatives, modifications, permutations and variations will become apparent to those skilled in the art in light of the foregoing description.

What is claimed is:

1. A method for increasing the accuracy of extrapolated motor vehicle data, comprising:
collecting a motor vehicle registration first data set and one or more motor vehicle manufacturer second data sets;
receiving and combining the first data set and at least one of the one or more second data sets;
indexing a number of vehicles manufactured by a particular manufacturer against a postal code of each of the registered owners of the vehicles within said first data set;
calculating one or more data biases within said combined first data set and one or more second data sets;
normalizing the one or more data biases by removing an unwanted demographic bias and producing a resulting analyzed data set;
analyzing the resulting analyzed data set for predicted human behavioral insights and providing a report upon said predicted human behavioral insights to a user;
said user planning and performing a travel action upon receiving said predicted human behavioral insights report.

2. The method of claim 1, where the one or more data biases reflect over-representation based upon manufacturer of said vehicle.

3. The method of claim 1, where correcting the one or more data biases is affected by applying a multiplier.

4. The method of claim 1, where the human behavioral insights reflect analysis of human travel behavior.

5. The method of claim 1, where the one or more motor vehicle second data sets are analyzed in real-time utilizing captured vehicle data.

6. The method of claim 5, where said captured vehicle data is captured using a digital device application.

7. A system for increasing the accuracy of extrapolated motor vehicle data, comprising:
a server with a processor in communication with one or more digital devices;
said server collecting a motor vehicle registration first data set and one or more motor vehicle manufacturer second data sets;
said server receiving and combining the first data set and at least one of the one or more second data sets;
said server indexing a number of vehicles manufactured by a particular manufacturer against a postal code of each of the registered owners of the vehicles within said first data set;
said server calculating one or more data biases within said combined first data set and one or more second data sets;
said server normalizing the one or more data biases by removing an unwanted demographic bias and producing a resulting analyzed data set;
said server analyzing the resulting analyzed data set for predicted human behavioral insights and providing a report upon said predicted human behavioral insights to a user;
said user planning and performing a travel action upon receiving said predicted human behavioral insights report from said server.

8. The method of claim 7, where the one or more data biases reflect over-representation based upon manufacturer of said vehicle.

9. The method of claim 7, where correcting the one or more data biases is affected by applying a multiplier.

10. The method of claim 7, where the human behavioral insights reflect prospective human travel behavior.

11. The method of claim 7, where the one or more motor vehicle second data sets capture real-time vehicle data.
